(19) United States
(12) Patent Application Publication
(10) Pub. No.: US 2025/0284050 A1
(43) Pub. Date: Sep. 11, 2025

(54) HIGH EFFICIENCY OPTICAL FIBER BRAGG GRATING DEVICE BASED ON MICROPORE FORMATION AND METHOD FOR PRODUCING SAME

(71) Applicant: NATIONAL RESEARCH COUNCIL OF CANADA, Ottawa (CA)

(72) Inventors: Abdullah RAHNAMA, Ottawa (CA); Cyril HNATOVSKY, Ottawa (CA); Rune LAUSTEN, Ottawa (CA); Stephen MIHAILOV, Kanata (CA); Ping LU, Stittsville (CA); Huimin DING, Nepean (CA); Robert WALKER, Spencerville (CA); Kasthuri DE SILVA, Kasthuri, Milton (CA)

(21) Appl. No.: 19/217,748

(22) Filed: May 23, 2025

Related U.S. Application Data
(63) Continuation-in-part of application No. 18/255,148, filed on May 31, 2023.
(60) Provisional application No. 63/665,318, filed on Jun. 28, 2024.

(51) Int. Cl. G02B 6/02; G01J 3/18

(52) U.S. Cl. CPC G02B 6/02133; G01J 3/1895; G02B 6/02085

(57) ABSTRACT

A method and apparatus for inscribing a Bragg grating in the core of an optical waveguide. Electromagnetic radiation at a chosen wavelength passes through a diffractive optical element optimized for the wavelength such that a beam is generated on the waveguide having an interference pattern so as to form a Bragg grating in the core of the optical waveguide, the beam being sufficiently intense to cause a permanent (Type II) change in the index of refraction in the core in the form of at least one elongated micropore. The Bragg grating period can be selected to promote coupling of guided light into a radiation mode for detection by a detector to form a spectrometer. The Bragg grating is characterized by a scattering loss less than 10⁻⁵ dB per grating period at the Bragg resonance but outcoupling efficiency at visible wavelengths of 0.03% per grating period.

### FIELD OF THE INVENTION

The present invention relates in general to the inscription of fiber Bragg gratings (FBGs) in optical fibers, and more particularly to using specialized transmission diffractive elements and femtosecond pulse duration lasers to inscribe a high-efficiency fiber Bragg grating based dispersive element for use in optical waveguide systems, such as fiber-optic spectrometers, inline fiber-optic taps, free-space fiber couplers and the like.

### BACKGROUND OF THE INVENTION

Optical spectrometers may be used to separate and measure spectral components, such as intensity of light as a function of wavelength or frequency, wherein the different wavelengths of light are separated by a diffraction grating, such as a FBG, for optical dispersion. FBG spectrometers have numerous applications, such as enhanced diagnostic functions in data centers and optical communication networks.

FBGs are versatile optical filters, which are photoinduced in the core of optical fiber waveguides using high powered lasers. Developed for the telecommunications industry, they are used in wavelength division multiplexing (WDM) applications to block or reflect wavelengths of light that are resonant with the Bragg grating structure. Each FBG has a characteristic retro-reflective Bragg resonance or Bragg wavelength (λ_{B}), which is dependent upon the periodicity of the grating photo-inscribed within the fiber (i.e., □_{G}) and the effective refractive index of the fundamental core mode of the optical fiber (i.e., n_{eff}) such that λ_{Br}=2 n_{eff} □_{G}. FBGs have traditionally been photo-inscribed into photosensitive germanium-doped (Ge-doped) silica fiber using ultraviolet (UV) radiation. They possess several attractive qualities such as electrically passive operation, electromagnetic interference (EMI) immunity, high sensitivity, and multiplexing capabilities.

Typically, FBGs are generated by exposing a UV-photosensitive Ge-doped silica core of an optical fiber to a spatially modulated UV laser beam in order to create refractive index changes in the fiber core that are permanent at room temperature. Such a spatially modulated UV beam can be created by using a two-beam interference technique such as disclosed in U.S. Pat. No. 4,807,950 by Glenn et al. or by using a phase mask as disclosed in U.S. Pat. No. 5,367,588 by Hill et al. The techniques taught by Glenn and Hill result in gratings that can be erased at temperatures significantly lower than the glass transition temperature and are typically referred to as Type I gratings. The index change associated with Type I gratings arises from the formation of color center defects that are created by the UV light. The induced index modulation comprising the grating exhibits low scattering loss, which is desirable for WDM applications.

Spectrometers using UV laser induced Type I FBGs with tilted grating planes are known where light is coupled directly out of the fiber, see for example U.S. Pat. No. 7,245,795 by Walker et al. (2007). Outcoupling of the guided core mode is achieved by tilting, blazing or slanting the grating planes with respect to the fiber axis. As the angle of the outcoupled radiation is dependent on the wavelength of the guided mode, placement of a detector such as a CCD array proximate the fiber may be used to create a fiber spectrometer (J. L. Wagener, T. A. Strasser, J. R. Pedrazzani, J. DeMarco, and D. DiGiovanni, “Fiber grating optical spectrum analyzer tap,” in Proc. Integr. Opt. Opt. Fibre Commun., 11th Int. Conf., 23rd Eur. Conf. Opt. Commun., 1997, pp. 65-68, doi: 10.1049/cp: 19971613).

However, the requirement to tilt the grating structure introduces a strong polarization dependence of outcoupled light on the tilt angle, requiring the use of additional optical components, such as prisms, lenses and mirrors. Also, such fibers must be photosensitized by hydrogen loading, which can only be applied to Ge-doped fiber and is therefore ineffective for other silica-based optical fibers. Furthermore, long exposure times are required to induce sufficient index changes for efficient outcoupling.

The fabrication of Bragg gratings using femtosecond pulse duration near-infrared laser radiation (fs-NIR) and a diffractive optical element in the form of a phase mask, as taught by Mihailov et al. in U.S. Pat. No. 6,993,221, results in Bragg gratings with very high index modulations (□n>10⁻³) that are stable at high temperature approaching the glass transition temperature of the optical fiber. These high temperature stable gratings are referred to as Type II gratings. More recently, Hnatovsky et al. showed in Opt. Lett., vol. 42, pp. 399-402, 2017 that by utilizing the exposure conditions taught in U.S. Pat. No. 6,993,221, form-birefringent planar self-organized nanostructures, which are similar to those demonstrated by Shimotsuma et al. in Phys. Rev. Lett., vol. 91, article 247405, 2003, can be created in the core of an optical fiber. Strong FBGs can be formed using the approach taught in U.S. Pat. No. 6,993,221, where the underlying Type II material modification introduces high scattering loss.

High scattering loss grating structures (Type II) can also be created in the core of an optical fiber with a fs-NIR laser but without a phase mask. Khrushchev et al. in International Patent Application Publication No. WO/2005/111677 teach how sequential (i.e., point-by-point) laser writing can be implemented with fs-NIR beams. In this case, the fs-NIR pulses are tightly focused inside the fiber core region using a microscope objective having a high numerical aperture (NA=0.45-0.55) and the period of the resultant Type II grating is defined by a ratio of the translation speed of a precision mechanical stage on which the fiber is mounted to the pulse repetition rate of the laser. Type II modification is produced in the core region with single laser pulses and is assumed to consist of voids surrounded by densified material. The effective refractive index in the optical fiber (or waveguide) is locally affected by the presence of a void in its vicinity. Even though Khrushchev et al. do not explicitly show the presence of voids in the core region, there exists extensive literature corroborating the formation of voids in transparent bulk materials by means of tightly focused fs-NIR radiation, for example, Glezer et al. in in U.S. Pat. No. 5,761,111 (1998), Schaffer et al. in U.S. Pat. No. 7,568,365 B2 (2009). The physics of the formation of fs-pulse-induced voids in transparent bulk materials is discussed in detail by Gamaly et al. in Phys. Rev. B vol. 73, pp. 214101 (2006).

Khrushchev et al. also note that voids, which underlie Type II modification in this case, are preferably positioned slightly outside of the core. In such a location the voids do not introduce significant losses to the transmitted light due to strong scattering, whereas the material surrounding the voids still intercepts the core and thus changes its effective refractive index. Alternatively, in order to have a high-contrast change of effective refractive index □n_{eff} at the expense of higher scattering loss, voids can be formed inside the core. In this case, according to Martinez et al. in IEEE Photonics Technol. Lett. Vol. 18, pp. 2266 (2006), Åslund et al. in Opt. Express vol. 16, pp. 14248 (2008) and Williams et al. in Opt. Express vol. 20, pp. 13451 (2012), the scattering loss of the resultant Type II FBGs is in the range from 10⁻⁴ dB to 2×10⁻³ dB per single void, i.e., per grating period, depending on the laser-writing conditions.

Taylor et al. in U.S. Pat. No. 7,438,824, teach a method of producing thermally stable fiber Bragg gratings that utilize a variation of the point-by-point technique. Taylor et al. use multiple femtosecond pulses that have intensities lower than the single-pulse intensity threshold required to produce a microvoid. In the case of Taylor et al., each Bragg grating plane is created by a superposition of pulses that causes an index change that is the result of the formation of self-organized nanogratings within the Bragg grating plane. The resultant index change of this Bragg grating is thermally stable up to 1000° C., if said Bragg grating is produced in fused silica, but also creates high scattering loss as in the aforementioned methods of Khrushchev, Åslund and Williams.

Waltermann in U.S. Pat. No. 11,698,302 teaches a method in which a femtosecond laser and the point-by-point FBG fabrication method of Khrushchev et al. are used to produce a fiber-optic spectrometer with high-scattering Type II induced index change sites within the core of an optical fiber. In this case, an untilted chirped FBG (CFBG) wherein the period of the grating structure varies linearly as a function of position is used. The induced index change within the fiber core is presumably ellipsoidal in nature. The CFBG is used as an integrated dispersive element for a fiber-optic spectrometer to analyze FBG sensor signals in the 810-870 nm range. The method taught by Waltermann does not require a sloped plane of induced index change for outcoupling and relies on high scattering from the index change site.

A variation of this point-by-point technique to create an fiber-optic spectrometer operable in the visible spectrum is disclosed in Rahnama et al. (“Ultracompact lens-less “Spectrometer in fiber” based on chirped filament array gratings,” Adv. Photon. Res., vol. 1, no. 2, 2020, Art. no. 2000026, doi: 10.1002/adpr.202000026), where instead of the creation of single-shot microvoids as taught by Waltermann, highly elongated regions of femtosecond laser induced index change or filaments that traversed the optical fiber were generated. The resultant filament-based grating structure enabled azimuthally symmetric diffraction maxima to travel in opposite directions outside the cladding. An additional chirping of the grating was introduced in order to focus the outcoupled light on the CCD array and thus provided a high-resolution of their fiber optical spectrometer without any focusing optics between the fiber and detector, which is a significant advantage of the CFBG as a diffraction grating. The main disadvantage of the FBG-based spectrometers taught by Waltermann and Rahnama et al. are their low outcoupling efficiency of ˜ 3%.

A further disadvantage of the point-by-point method to create localized regions of index change or filaments in the grating planes is that the process requires high precision (nanometer resolution) translation stages and thousands of optical pulses depending on the length of the grating. This is a time-consuming process and repeatability of the grating structure is dependent upon the spatial precision of the translation stages.

It is an objective of this invention to overcome the aforementioned limitations of the prior art.

The following additional prior art is relevant as background information: U.S. Pat. Nos. 6,878,900; 6,884,960; 7,031,571; 7,033,519; 7,379,643; 7,483,615; 7,515,792; 7,606,452; 7,689,087; 8,272,236; 8,402,789; 8,727,613; 10,156,680; 10,520,669; 10,886,125; 11,359,939; and Patent Publication Application Nos US2021/0318488; US2023/0333313; US2023/0194775; US2024/0012195 and PCT/IB2020/050187.

### SUMMARY OF THE INVENTION

The present invention builds on the techniques set forth in U.S. patent application Ser. No. 18/255,148, filed Dec. 4, 2020 (the ‘148 application’), the contents of which are incorporated herein by reference, which teaches a method and apparatus for inscribing Type II gratings in optical fiber that create low insertion loss gratings at the Bragg resonance. Using a phase mask and a single pulse from a high-powered fs-NIR laser, a distinctive Type II change in the index of refraction within each of the many (i.e., thousands) Bragg grating planes in the core of the optical fiber is created. Specifically, the deposition of a single laser pulse results in the formation of a thermally stable single micropore for each grating plane. The combination of a phase mask with a fs-NIR laser technique set forth in the ‘148 application’, can be used to fabricate FBGs that possess thermal and spectral characteristics of highly localized FBGs produced by the point-by-point technique but have a much lower scattering loss at or near the Bragg resonance. Additionally, the technique set forth in the ‘148 application’ is highly useful for mass production since laser writing based on the phase mask technique i) is generally very robust and reproducible and ii) represents parallel laser writing as opposed to sequential laser writing based on the point-by-point technique.

As set forth below, and as discussed in Abdullah Rahnama, Cyril Hnatovsky, Rune Lausten, Robert B. Walker, Kasthuri De Silva, AND Stephen J. Mihailov, “Highly Efficient Fiber Bragg Grating Spectrometer Fabricated with Violet and Near-Infrared Femtosecond Laser Pulses and the Phase Mask Technique”, Vol. 50, No. 3/1 Feb. 2025/Optics Letters, the inventors have developed a phase mask having a finer period and femtosecond pulsed radiation having a reduced wavelength compared with what is taught by the ‘148 application’. These two developments allowed the production of Type II Bragg gratings in a fiber that transmits visible light in the single mode regime, such as required for visible fiber-optic spectrometers, whose outcoupling efficiency over all diffraction can be 70% or higher (i.e., two-orders of magnitude higher as compared with previously reported values).

The FBG set forth herein may be used to outcouple light into radiation modes that are resonant with the grating structure. The radiation mode and its angle with respect to the fiber axis depends on the wavelength of light propagating in the fiber and the period of the grating. The length of the micropore controls the azimuthal spreading of the light within the radiation mode and the low scattering of the micropore allows for concatenation of tens of thousands of grating planes for efficient outcoupling of the majority of light in the fiber into radiation modes, which cannot be accomplished using the teachings of Waltermann.

In an aspect, as set forth in detail below, a method for inscribing a Bragg grating in the core of an optical waveguide is described for use in an optical fiber system, comprising the steps of providing electromagnetic radiation at a wavelength chosen for the optical waveguide system; focusing the electromagnetic radiation through a diffractive optical element optimized for the wavelength such that when exposed to the focused electromagnetic radiation a beam is generated on the optical waveguide having an interference pattern; irradiating the optical waveguide with the beam to form a Bragg grating, the beam incident on the optical waveguide being sufficiently intense to cause a permanent (Type II) change in the index of refraction in the core of the optical waveguide in the form of at least one micropore; and wherein the Bragg grating period is selected to promote coupling of guided light into a radiation mode.

Additionally, an optical waveguide is set forth with an inscribed Bragg grating prepared according to the method as described herein.

Furthermore, an optical fiber is set forth with an inscribed Bragg grating, wherein the Bragg grating has a scattering loss of less than 10⁻⁵ dB per grating period, has spectral reflectivity at the fundamental Bragg resonance that results in a transmission below −10 dB (i.e. 90% reflectivity) for a 15 mm FBG length, and is stable at a temperature up to the glass transition temperature of the optical fiber.

In another aspect, an optical waveguide system is described, comprising an optical waveguide having a core in which a Bragg grating containing micropores is formed; and a detector placed adjacent to the optical waveguide to receive scattered light from the Bragg grating containing micropores.

In a further aspect, system for inscribing a Bragg grating onto an optical waveguide having a core is described, comprising a laser for generating ultrashort pulse duration electromagnetic radiation at a selected wavelength; a focusing optical element for focusing the ultrashort pulse duration electromagnetic radiation from the laser onto the optical waveguide; and a diffractive optical element intermediate the focusing optical element and the optical waveguide optimized for receiving the electromagnetic radiation and generating a beam having an interference pattern for irradiating the optical waveguide so as to form a Bragg grating therein, the electromagnetic radiation incident on the optical waveguide being sufficiently intense to cause a permanent (Type II) change in the index of refraction in the core of the optical waveguide in the form of at least one micropore.

In the present application, references to “a permanent change in an index of refraction within a core of the optical fiber” represents the formation of a grating that is stable at a temperature up to just below the glass transition temperature of the material forming the optical fiber. This is also referred to herein and in the art as a Type II Fiber Bragg grating. In one embodiment, where the waveguide is a silica-based fiber, and a permanent change in the index of refraction within a core of the optical fiber is one which is stable at temperatures of up to 1000° C.

### BRIEF DESCRIPTION OF DRAWINGS

These together with other aspects and advantages, as well as a discussion of the prior art, are more fully set forth below, reference being had to the accompanying drawings forming a part hereof, wherein like numerals refer to like parts throughout.

FIG. 1 depicts a fiber Bragg grating (FBG) spectrometer based on tilted Bragg gratings, according to the prior art.

FIG. 2 depicts a FBG spectrometer based on point-by-point femtosecond laser inscribed Bragg gratings, according to the prior art.

FIG. 3 depicts an interferometric setup based on the phase mask technique for the inscription of a FBG with micropore based index change, according to the ‘148 application’.

FIGS. 4A and 4B depict interferometric setups using near-infrared and violet femtosecond sources to produce FBGs with grating periods Λ_{G}=536 nm and Λ_{G}=300 nm, respectively.

FIG. 5 depicts a self-focusing, all-fiber spectrometer utilizing a micropore-based FBG, according to an embodiment, with the outcoupled spectrum in focus.

FIG. 6 is a comparison of reconstructed outcoupled visible radiation patterns of the FBG spectrometer in FIG. 5 (dashed line) with that of an optical spectrum analyzer (solid line).

FIG. 7 depicts the maximum outcoupling efficiency over all diffraction orders for the FBG spectrometer of FIG. 5, with Λ_{G}=536 nm (NIR written) and Λ_{G}=300 nm (violet written) at three wavelengths (i.e., 405 nm, 520 nm and 637 nm).

FIG. 8 depicts a test set up using a motorized fiber polarization controller to measure the polarization dependence of the outcoupling efficiency.

FIG. 9A shows polarization dependence of the outcoupling efficiency for a FBG with Λ_{G}=536 nm (NIR written), and FIG. 9B shows a FBG with Λ_{G}=300 nm (violet written), where the outcoupling efficiency is measured as a function of the rotation angles of the half- and quarter-wave plate paddles of the polarization controller of FIG. 8.

FIG. 10A depicts how the azimuthal directionality of a pair of outcoupled diffraction orders with a given m depends on the length of micropores that form a FBG, and FIG. 10B depicts how the azimuthal directionality of a single outcoupled diffraction order with a given m depends on the length of micropores that form a FBG.

### DETAILED DESCRIPTION OF THE INVENTION

As discussed above, the inventors teach in the ‘148 application’ that FBGs with extremely low scattering loss at wavelengths close to but not at the Bragg resonance—less than 10⁻⁵ dB per grating period—can be fabricated in silica fibers by utilizing the phase mask technique for grating inscription using a fs-NIR laser to induce Type II modification in the fiber core. Although these FBGs have low scattering loss in the infrared, the inventors have discovered that the FBGs strongly scatter guided light that is at visible wavelengths. Outcoupling efficiencies of 0.03% per grating period have been observed. Scanning electron microscopy (SEM) has established that for single-pulse irradiation through the phase mask, every grating plane of the FBG produced under these conditions, as seen by light guided in the fiber, consists of a highly elongated micropore embedded within a narrow region of resolidified glass. Thus, the phase mask technique combined with a fs-NIR laser can be used to fabricate FBGs that possess outcoupling characteristics of highly localized FBGs produced by the point-by-point technique. As set forth below, the high outcoupling efficiency of light from the fiber, i.e., the high efficiency of coupling guided light to radiation modes, is useful for creating a fiber spectrometer.

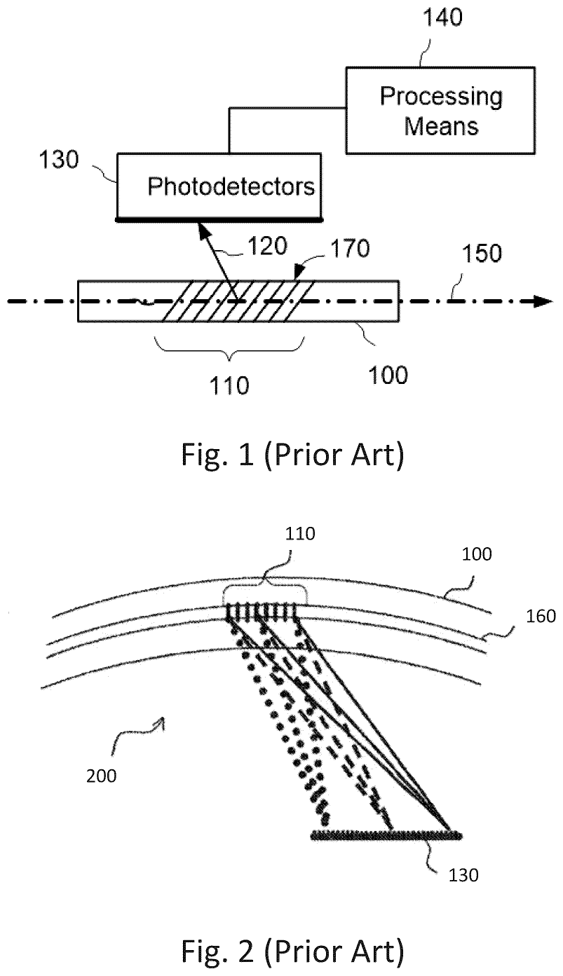

FIG. 1 shows a prior art example of an optical fiber spectrometer based on UV laser induced tilted Bragg gratings as taught by Walker et al. U.S. Pat. No. 7,245,795. A tilted FBG 110 is formed within an optical fiber 100 in such a way that, when light at a wavelength λ propagating along the fiber 100 impinges upon the FBG 110, at least a portion of it, the outcoupled light 120, is coupled out of the fiber 100 through a side surface thereof 170, and dispersed by the FBG 110 azimuthally about an optical axis 150 of the fiber 100 to photodetectors 130 in dependence on the wavelength 2. This is accomplished by selecting the FBG parameters so that, for a predetermined operating wavelength range, the FBG 110 operates substantially away from the Bragg resonance condition.

FIG. 2 shows a prior art example of an optical fiber spectrometer 200 based on femtosecond laser induced point-by-point gratings as taught by Waltermann in U.S. Pat. No. 11,698,302, wherein the core 160 of fiber 100 has an FBG 110 inscribed therein, as in FIG. 1, however the fiber 100 and inscribed FBG 110 bend with a curvature that leads to constructive interference such that different wavelengths are focused at different locations on photodetectors 130, which largely simplifies the structure of the spectrometer.

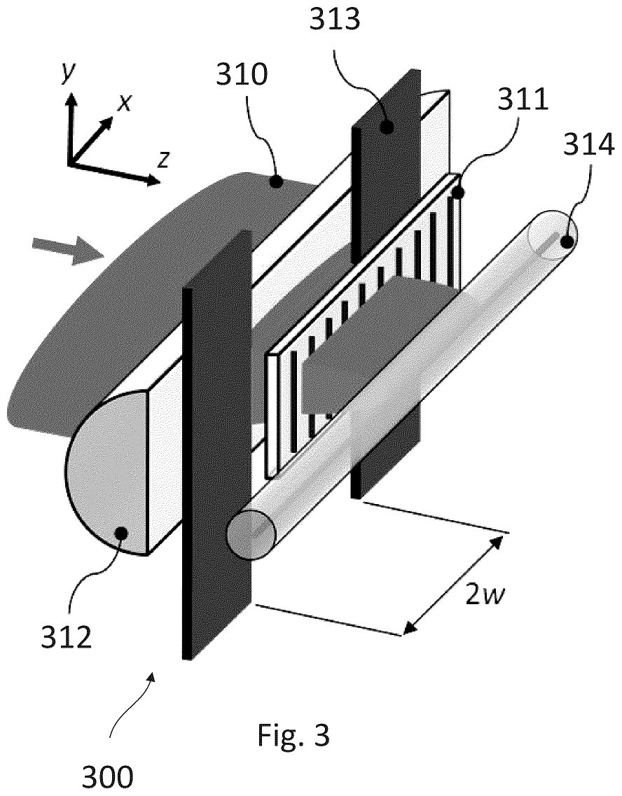

Turning to FIG. 3, apparatus 300 is shown for fabrication of a micropore-based FBG with a femtosecond pulse duration near-infrared laser and a phase mask, according to the ‘418 application’. A linearly polarized femtosecond beam 310 is generated, for example, by a regeneratively amplified Ti:sapphire femtosecond laser system with transform limited 80 fs pulses at a central wavelength of 800 nm. The beam 310 is expanded ˜3.5 times in the horizontal plane (i.e., along the x-axis, FIG. 3) and focused through a zeroth-order-nulled holographic phase mask 311 with a pitch. □_{G}=1.072 □m (mask grooves are aligned along the y-axis) using a plano-convex cylindrical lens 312 (15 mm focal length) having its curved surface corrected for spherical aberration in one dimension. The effective numerical aperture of the cylindrical lens 312 in the yz-plane is estimated at ˜0.25. The beam expansion is used to produce a quasi-flat-top intensity distribution along the x-axis at the cylindrical lens 312. A slit 313 of width 2w≈15 mm is aligned along the y-axis and placed between the plano-convex cylindrical lens 312 and the phase mask 311. Optical fiber 314 (for example a fiber transmitting visible light in the single-mode regime such as SMF460HP) with its protective coating removed, is placed ≈300 □m away from the phase mask 311 where the peak intensity in the focus is highest. The location of the highest peak intensity may be determined using the technique taught by Abdukerim et al. in Opt. Express vol. 27, pp. 32536-32555 (2019), incorporated herein by reference. To inscribe FBGs, the regeneratively amplified Ti:sapphire femtosecond laser system is operated at 1 Hz and the pulses are fired at the optical fiber 314 one at a time using a synchronized shutter.

The inventors have discovered that finer Bragg grating periods can be created by reducing the period of the phase mask 311 used to inscribe the pattern. The wavelength of the femtosecond laser beam also needs to be reduced, such that it is always less than the mask period. To reduce the femtosecond laser wavelength, the femtosecond beam can, for example, be frequency doubled with a 0.5 mm-thick BBO crystal (β-Ba (BO₂)₂) resulting in the generation of the beam 310 having 110 fs violet pulses centered at a wavelength of 400 nm. The phase mask 311 can therefore have a pitch >400 nm.

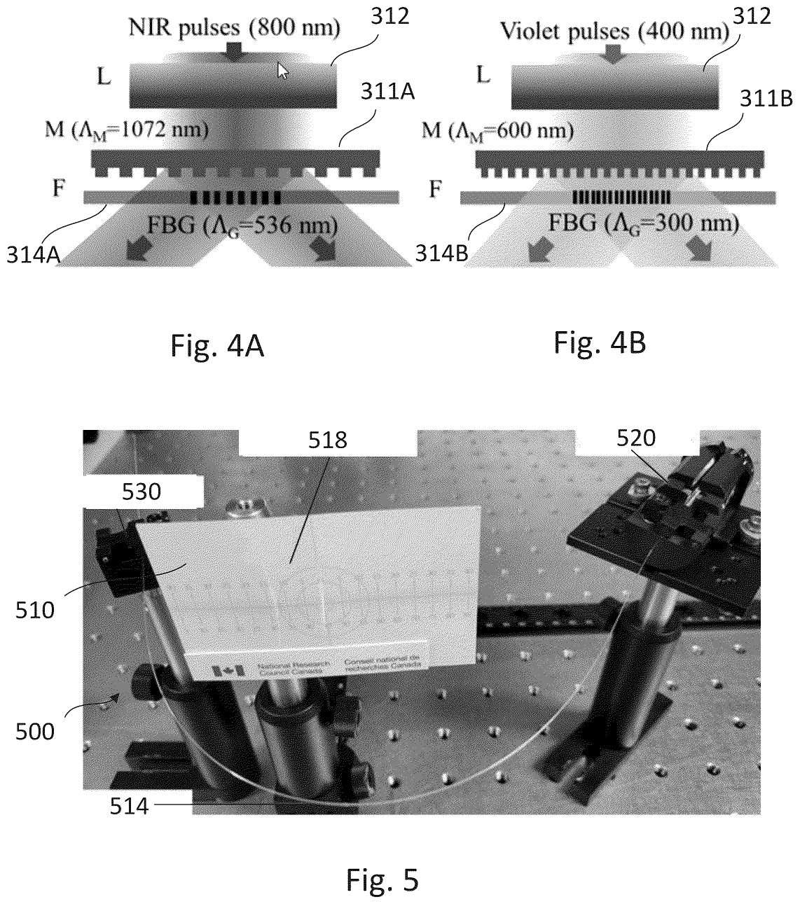

FIGS. 4A and 4B depict phase mask interferometric setups using near-infrared and violet femtosecond sources to produce FBGs with grating periods Λ_{G}=536 nm and Λ_{G}=300 nm, respectively. Specifically, FIG. 4A depicts the setup of FIG. 3, using a mask 311A with a pitch Λ_{M}=1072 nm irradiated by a focused fs-NIR (800 nm) beam to create a grating structure within fiber 314A having a grating pitch of Λ_{G}=536 nm, while FIG. 4B depicts the setup, according to an embodiment, using a mask 311B with a pitch Λ_{M}=600 nm irradiated by a violet (400 nm) femtosecond beam to create a grating structure within fiber 314B having a grating pitch of Λ_{G}=300 nm. FBGs produced using femtosecond pulses at 400 nm-800 nm can efficiently outcouple guided light within a wavelength range of 250 nm-2000 nm, which covers the wavelengths of light that silica fibers can easily transmit. However, if other single mode fibres are used, such as ZBLAN fluoride-based glass fibers, the wavelength range can expand into the mid infrared (˜5500 nm from 2000 nm for silica).

If a FBG with a uniform period Λ_{G} is probed by light with a wavelength/at which the fiber is single mode, the diffraction orders outcoupled from the fiber core into the fiber cladding obey the following equation:

mλ=nΛ_{G}(1+sin θ_{D}^{(m)}) (1)

where m is the order of diffraction, θ_{D}^{(m)} is the internal diffraction angle with respect to the normal to the fiber axis for light outcoupled into diffraction order m, and n is the refractive index of the fiber material (the fiber core and the fiber cladding are assumed to have the same refractive index).

If the phase mask with a uniform period converts the femtosecond beam into a two-beam interference pattern, with which the FBG inscription is performed, then the relation between Λ_{G} and Λ_{M} is Λ_{G}=Λ_{M}/2.

From Equation (1),

sin θ_{D}^{(m)}=[mλ/(nΛG)]−1 (2)

noting that the absolute value of sin θ_{D}^{(m)} must be less than or equal to 1.

Using Equation (1) and Snell's law at the air-fiber cladding interface, it can be shown that the angle θ_{DF}^{(m)} at which light in diffraction order m is outcoupled with respect to the normal to the fiber axis is given by

θ_{DF}^{(m)}=arcsin[(mλ/Λ_{G})−n]180°/p (3)

The spectral range Δλ within which only ±1st (m=1) diffraction orders are outcoupled from the fiber to the surrounding space can be found by using Equation (2) and Equation (3). The shortest wavelength λₘᵢₙ at which light is not outcoupled from the fiber core into ±2nd (m=2) and higher (m>2) diffraction orders is determined by the condition sin θ_{D}⁽²⁾=1. In this case, according to Equation (2), λₘᵢₙ=nλ_{G}. According to Equation (3), the longest wavelength Amax at which light in +1st (m=1) diffraction orders can still be outcoupled from the fiber into the surrounding space, i.e., when total internal reflection of the light does not take place at the air-fiber cladding interface, is determined by the condition (λ/Λ_{G})−n=1. In this case, λₘₐₓ=(n+1)/G. Hence, taking into account that Δλ=λₘₐₓ−λₘᵢₙ, Δλ is given by

Δλ=Λ_{G} (4)

Following Equations (1)-(3), the number of diffraction orders into which light with a wavelength λ is outcoupled from the fiber core to the fiber cladding and from the fiber cladding to the surrounding space can be selected (i.e., optimized for an application) by changing Λ_{G}. For example, if the light from a laser source with 2=520 nm is coupled into the core of a single-mode fiber and the protective coating is removed from the fiber, a FBG with Λ_{G}=536 nm (Λ_{M}=1072 nm) written with NIR femtosecond pulses (800 nm) allows the outcoupling of +1st (m=1) and ±2nd (m=2) diffraction orders from the fiber. By reducing the wavelength of the femtosecond pulses, for example by frequency doubling the original NIR femtosecond pulses, phase masks with finer pitches Λ_{M} can be used and, as result, FBGs with finer pitches produced. By using Equations (2) and (3), it can be shown that Λ_{G} can be selected such that light is outcoupled into only one diffracted order pair. For example, a FBG with Λ_{G}=300 nm created using a phase mask with Λ_{M}=600 nm and violet femtosecond pulses (400 nm) produces outcoupling into only ±1st diffraction orders.

Equations (2)-(4) allow one to design FBGs suitable for different applications that are based on outcoupling of light from the fiber. For instance, Equations (2) and (3) define for a given wavelength λ what period Λ_{G} is needed in order to have radiation in +1st diffraction orders outcoupled at 90° to the fiber axis.

The unique geometry of the micropore enables strong coupling of the guided mode to radiation modes, which is not possible with traditional planar Bragg grating structures, including tilted FBGs. By bending the fiber at the FBG location, the radiation modes can be focused on a flat surface, such as a CCD/CMOS sensor, without the need for additional focusing optics.

FIG. 5 shows a schematic image of a self-focusing, all-fiber spectrometer 500 according to an embodiment, with the radiated spectrum in focus for two colors (λ=520 nm and λ=637 nm). The outcoupled spectrally narrow light is sharply focused onto a paper card 510 at 518 by bending fiber 514 at the FBG location, by means of a fiber rotator 520 and fiber clamp 530, with the bending radius in this instance being approximately 50 mm.

The efficiency and resolution of the FBG spectrometers were validated experimentally using narrow-band visible laser diode sources. The spectral intensity profiles were captured with a CMOS beam profiler having a 5.5 μm pixel pitch located at the focal plane of the bent fiber 514. The bent micropore-based FBG provided a strong linear dispersion of ˜210 μm at the focal plane (i.e., the paper card 518) per 1 nm of guided wavelength.

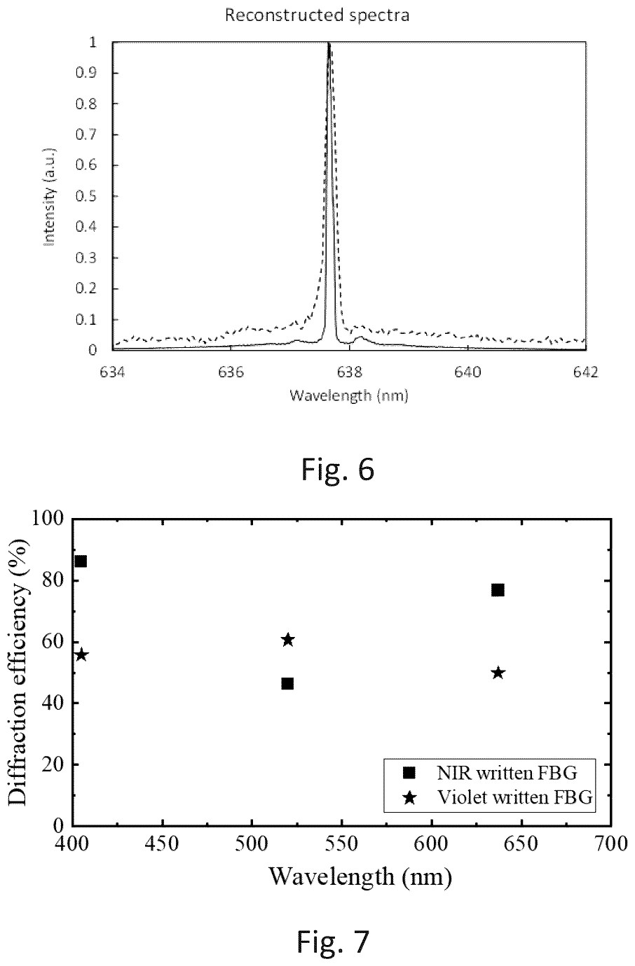

FIG. 6 shows an example of reconstructed spectrum (black dashed line) of the visible Fabry-Perot laser source at λ=637 nm compared to the spectrum (black line) recorded using a high-resolution (30 pm) optical spectrum analyzer (OSA), wherein the exemplary spectrometer 500 resulted in a ≈200 pm spectral resolution in the visible band. Altering the bend curvature of the fiber 514 by means of the rotator 520 results in easy adjustment of the spectral resolution and working bandwidth of the spectrometer 500, however it is not possible with prior art fiber spectrometers based on chirped FBGs as taught by Waltermann in U.S. Pat. No. 11,698,302 or bulky lenses and dispersive components as disclosed by Qin et al. in Optics Letters 44, 5129-5132 (2019) to provide fiber-optic spectrometers based on Type II FBGs with a 300 nm pitch (smaller pitches are possible) as well as the ability to produce such spectrometers using the phase mask technique, which is robust and reproducible.

In fact, the exemplary FBG 500 spectrometer is capable of resolving peaks as narrow as ˜250 pm (at FWHM) across the visible spectrum. A similar resolution was achieved with the FBGs with Λ_{G}=300 nm. The maximum theoretical spectral resolution achievable with a FBG spectrometer is given by 2/N, where λ is the wavelength of guided light to be analyzed and N is the number of grating planes in the FBG. For a 15 mm long FBG with Λ_{G}=536 nm, N is ˜2.8×10⁴ and consequently the maximum resolution is 23 pm at λ=637 nm. For a 6 mm long FBG with Λ_{G}=300 nm, N is ˜2×10⁴ and its maximum theoretical resolution at λ=637 nm would be 32 μm. In both cases, the maximum achieved resolution (i.e., ˜250 pm) of the devices based on FBGs with Λ_{G}=536 nm and Λ_{G}=300 nm is lower than its theoretical limit, mainly because of optical aberrations originating from the cylindrical shape and bending of the fiber.

One of the main challenges with fiber-based spectrometers is their low outcoupling efficiency as disclosed by Rahnama et al. Adv. Photon. Res., vol. 1, no. 2, 2020, Art. no. 2000026. However, the exemplary spectrometer 500, which is based on micropore FBGs, has significantly enhanced coupling efficiency to radiation modes and, as a result, enhanced outcoupling efficiency. The outcoupling efficiency is the ratio of the power of the outcoupled light to the power of the input fiber-coupled light. FIG. 7 illustrates the outcoupling efficiency of spectrometer 500 based on FBGs with Λ_{G}=536 nm and Λ_{G}=300 nm. The outcoupling efficiency of the FBG with Λ_{G}=536 nm was ˜86% at λ=405 nm, 46% at λ=520 nm, and ˜76% at λ=635 nm, with the average value being ˜70%. In the case of the FBG with Λ_{G}=300 nm, the wavelength-dependent variation of the outcoupling efficiency was smaller, namely, ˜55% at λ=405 nm, ˜60% at λ=520 nm, and ˜49% at 2=637 nm, with the average value being ˜54%.

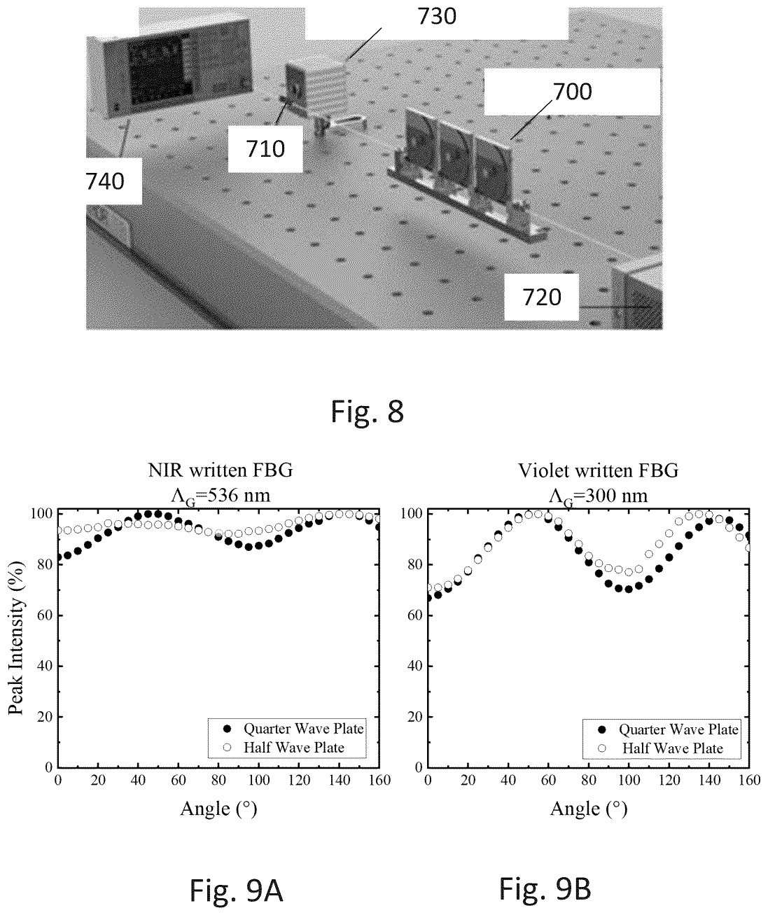

FIG. 7 reveals that the radiation modes, i.e., the outcoupled light, have a polarization dependence. To measure the polarization dependence of the outcoupling efficiency, a motorized fiber polarization controller 700 was placed before a FBG 710 under test, as shown in the experimental setup of FIG. 8. A Fabry-Perot laser source 720 emitting light at 2=405, 520 and 635 nm, provided a linearly polarized output. By rotating the half-wave and quarter-wave plate paddles of the polarization controller 700, one at a time, the input state of polarization was varied and changes in the power of the outcoupled light were recorded from one side of the FBG 710 using an integrating sphere power meter 730, while the transmitted power was measured using a regular OSA 740.

The outcoupling efficiency of the spectrometers based on FBGs with Λ_{G}=536 nm and Λ_{G}=300 nm is presented in FIG. 8. The outcoupling efficiency of the FBG with Λ_{G}=536 nm was ˜86% at 2=405 nm, 46% at 2=520 nm, and ˜76% at 2=635 nm, with the average value being ˜70%. In the case of the FBG with Λ_{G}=300 nm, the wavelength-dependent variation of the outcoupling efficiency was smaller, namely, ˜55% at λ=405 nm, ˜60% at λ=520 nm, and ˜49% at λ=637 nm, with the average value being ˜54%.

FIGS. 9A and 9B show the polarization-dependent variation of the outcoupled power for the FBGs with Λ_{G}=536 nm and Λ_{G}=300 nm when the quarter-waveplate (solid circles) or half-wave plate (empty circles) of the polarization controller is rotated in 5° increments. FIG. 9A shows that the FBGs written with the NIR femtosecond pulses (Λ_{G}=536 nm) exhibit a weaker polarization dependence of the outcoupling efficiency compared to the FBGs written with the violet pulses (Λ_{G}=300 nm). More specifically, the outcoupled power deviates by 18% and 30% from its peak value, respectively, when the quarter-wave and half-wave plates are rotated (FIGS. 9A and 9B). The relatively low polarization dependence of the outcoupled light is believed to be due to the material modification morphology of the devices wherein each grating plane consists of a single elongated micropore produced with a ≈35 nJ single pulse or ≈10 nJ double pulses.

In summary, an all-fiber optical system is set forth herein using the phase mask technique and one or two femtosecond pulses, thus eliminating the need to incorporate additional focusing and collimating optics into the spectrometer's design. The spectral range (Equation (4)) of optical fiber systems incorporating short-period FBGs that consist of micropores is from Δλ˜400 nm to Δλ˜ 700 nm with a sub-nanometer resolution. The unique morphology of the micropore structures within the fiber core facilitates strong outcoupling, paving the way for the fabrication of highly efficient optical fiber systems. High efficiency of the optical fiber systems yields a wide range of applications, from biotechnology to telecommunications.

Other embodiments of the invention can utilize phase masks with smaller pitches (i.e., smaller Λ_{M}) to produce fundamental Bragg resonances in the visible portion of the electromagnetic spectrum and ultraviolet femtosecond laser radiation in order to generate single order (i.e., ±1st diffraction order) outcoupling from the dispersive FBG element. The phase mask approach to produce micropore-based FBGs using a femtosecond laser is more repeatable and less time consuming than prior art techniques, making fiber spectrometer fabrication more reproducible and in less time than using the point-by-point femtosecond laser technique. Importantly, Type II FBGs with Λ_{G}=300 nm can be produced with ultraviolet (wavelength from 150 nm to 400 nm) or visible (wavelength shorter than 600 nm) femtosecond pulses. Such ultrashort pulses are characterized by a pulse duration of less than or equal to about 1 picosecond.

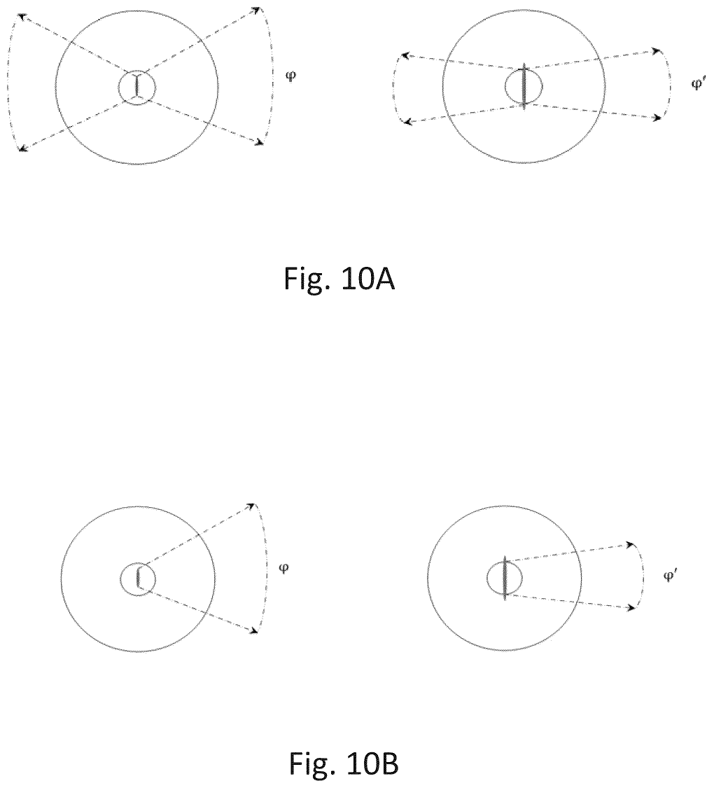

Hnatovsky et al. showed in Optics Express vol. 30 issue 26 pgs. 47361-47374 (2022) that it is possible to inscribe a number of Bragg gratings consisting of micropores that are stacked one on top of the other along the cross-section of the fiber core normal to fiber axis in order to make a 2-dimensional grating array. Rahnama et al. showed in the Proceedings of the SPIE vol. 11676 article 116760Y (2021) that such a 2-D grating array across the fiber cross section can result in preferential outcoupling of diffracted light into a single diffracted order, thus further improving the efficiency of the fiber spectrometer. According to another embodiment, a 2-D grating array can be inscribed consisting of at least 2 rows of micropore gratings to promote coupling into a single diffracted order, e.g., m=+1. The physical length of the micropores and/or variation in the number of them alters the azimuthal directionality of the outcoupled light patterns in a plane orthogonal to the fiber axis, as depicted in FIGS. 10A and 10B. The azimuthal directionality of a pair of outcoupled diffraction orders with a given m (FIG. 10A) or a single outcoupled diffraction order with a given m (FIG. 10B) is defined by the subtended angle j. For a given fiber core diameter, j is larger for shorter micropores and is smaller for longer micropores.

As discussed above, Equations (1)-(3) may be applied to optimize the grating period Λ_{G} to produce a radiation mode outcoupling at a wavelength of interest. For example, a further embodiment of the invention relates to the production of an optical tap (i.e., an in-line optical power tapping device) to monitor, for example, network traffic in fiber-optic telecommunications networks, optical power in fiber-optic delivery systems, and output or intra-resonator optical power of fiber-optic lasers. Based on Equation (2), an untilted Bragg grating with a period Λ_{G}=1.0675 μm generates an outcoupled beam that is at 90° with respect to the fiber axis when the light guided by the fiber is at 1550 nm, within the telecom C-band. With a detector placed adjacent to the fiber, this Bragg grating could then be used as an optical tap to monitor network traffic. It is important to note that according to U.S. Pat. No. 6,993,221, the grating with a period Λ_{G}=1.0675 μm will also have a second order retroreflective Bragg resonance at 2=1543 nm which falls within the telecom C-band, thus nullifying the radiative out-tapping/outcoupling at that wavelength. To avoid this situation, a Bragg grating could be fabricated with a 2nd order Bragg resonance that falls outside the telecom S-, C- and L-bands (1460-1530 nm, 1530-1565 nm, and 1565-1625 nm, respectively). For example, a FBG with Λ_{G}=1.000 μm has a 2nd order Bragg resonance at λ˜1450 nm, i.e., below the telecom S-band, but the out-tapped/outcoupled radiation is still at a near-normal angle to the fiber axis (i.e., 86°) when the wavelength of the light propagating in the fiber is in the center of the C-band.

In embodiments of the invention, the outcoupled power in the ±1st diffraction orders exceeds one of either 50% or 50% divided by the number of grating planes N (i.e., 0.03% per Bragg grating plane).

The efficient outcoupling of light demonstrated by micropore-based Bragg gratings according to this specification, is not limited to fiber spectrometers and network monitoring optical taps. Other applications of the invention include free space coupling devices, directional in vivo thermal beam sources for endoscopic medical therapeutics, directional in vivo imaging methods, such as, but not limited to optical coherence tomography or photoacoustic imaging, surface plasmon based sensors for micropore-based Bragg gratings with metallic coating on the fiber to name but a few.

The many features and advantages of the invention are apparent from the detailed specification and, thus, it is intended by the appended claims to cover all such features and advantages of the invention that fall within the scope of the claims. For example, a person of skill in the art will understand that an optical fiber is a specific kind of optical waveguide. Accordingly, the principles set forth herein may be applied to other forms of optical waveguides such, for example, an embodiment where FBGs are inscribed in optical planar waveguides made in a microfabrication facility. Numerous other modifications and changes will readily occur to those skilled in the art. It is not desired to limit the invention to the exact construction and operation illustrated and described, and accordingly all suitable modifications and equivalents may be resorted to, falling within the scope of the invention.

What is claimed is:

1. A method for inscribing a Bragg grating in the core of an optical waveguide for use in an optical waveguide spectrometer system, comprising the steps of:
providing electromagnetic radiation at a wavelength chosen for the optical waveguide system;
focusing the electromagnetic radiation through a diffractive optical element optimized for the wavelength such that when exposed to the focused electromagnetic radiation a beam is generated on the optical waveguide having an interference pattern;
irradiating the optical waveguide with the beam to form a Bragg grating, the beam incident on the optical waveguide being sufficiently intense to cause a permanent (Type II) change in the index of refraction in the core of the optical waveguide in the form of at least one micropore; and wherein the Bragg grating period is selected to promote coupling of guided light into a radiation mode.

2. The method of claim 1, wherein the electromagnetic radiation comprises a single ultrashort laser pulse.

3. The method of claim 1, wherein the electromagnetic radiation comprises a plurality of ultrashort laser pulses.

4. The method of claim 1, wherein the electromagnetic radiation has a pulse duration of less than or equal to about 1 picosecond.

5. The method of claim 1, wherein the wavelength of the electromagnetic radiation is in a range from about 150 nm to 2.0 microns.

6. The method of claim 1, wherein the optical waveguide system is a spectrometer, and the period of the diffractive optical element is optimized for a wavelength of the electromagnetic radiation to form said Bragg grating having a period such that when about 250 nm-5500 nm light propagates in the waveguide the outcoupling of said light into radiation modes in the form of ±1st diffraction orders.

7. The method of claim 6, wherein the outcoupled power in the ±1st diffraction orders exceeds one of either 50% or 50% divided by the number of grating planes.

8. The method of claim 1, wherein the optical waveguide system is an inline optical power monitor, and the period of the diffractive optical element is optimized for a wavelength of the electromagnetic radiation to form said Bragg grating having a period such that when about 250 nm-5500 nm light propagates in the waveguide the outcoupling of said light into radiation modes in the form of ±1st diffraction orders and the outcoupling of said diffraction orders is at ±30° with respect to the normal to the fiber axis.

9. The method of claim 3, wherein the plurality of ultrashort laser pulses is equal to or less than ten.

10. The method of claim 1, wherein the change in the index of refraction within the core of the optical waveguide comprises at least one elongated micropore.

11. The method of claim 1, wherein the change in the index of refraction within the core of the optical waveguide comprises a plurality of spherical micropores.

12. The method of claim 1, wherein the change in the index of refraction of a single plane of the Bragg grating within the core of the optical waveguide comprises a single spherical micropore.

13. The method of claim 1, wherein light propagating in the waveguide is outcoupled by the Bragg grating into a single pair of diffraction orders.

14. The method of claim 13, wherein the period of the Bragg grating is selected to alter the outcoupling angle of the diffraction orders with respect to the normal to the fiber axis.

15. The method of claim 10, wherein the length of micropores or the number thereof are varied to alter the azimuthal directionality of the outcoupled diffraction orders.

16. An optical waveguide system, comprising:
an optical waveguide having a core in which a Bragg grating containing micropores is formed; and
a detector placed adjacent to the optical waveguide to receive scattered light from the Bragg grating containing micropores.

17. The optical waveguide system of claim 16, wherein the waveguide is an optical fiber comprising at least one light-guiding core and a cladding.

18. The optical fiber system of claim 16, wherein the Bragg grating comprises at least two rows of micropore Bragg gratings forming a two-dimensional grating array across the cross-section of the core in order to promote outcoupling into one of either a +1 or −1 diffraction order.

19. The optical waveguide system of claim 16, wherein the Bragg grating is a chirped Bragg grating.

20. The optical waveguide system of claim 16, wherein the Bragg grating has a period optimized for use as a spectrometer.

21. The optical waveguide system of claim 16, wherein the Bragg grating has a period optimized for use as an in line optical power monitor.

22. A system for inscribing a Bragg grating onto an optical waveguide having a core, comprising:
a laser for generating ultrashort pulse duration electromagnetic radiation at a selected wavelength;
a focusing optical element for focusing the ultrashort pulse duration electromagnetic radiation from the laser onto the optical waveguide; and
a diffractive optical element intermediate the focusing optical element and the optical waveguide optimized for receiving the electromagnetic radiation and generating a beam having an interference pattern for irradiating the optical waveguide so as to form a Bragg grating therein, the electromagnetic radiation incident on the optical waveguide being sufficiently intense to cause a permanent (Type II) change in the index of refraction in the core of the optical waveguide in the form of at least one micropore.
